(19) United States
(12) Patent Application Publication
(10) Pub. No.: US 2026/0056652 A1
(43) Pub. Date: Feb. 26, 2026

(54) RESOURCE INTEGRATION METHOD, ELECTRONIC DEVICE, AND STORAGE MEDIUM

(71) Applicant: GUANGDONG OPPO MOBILE TELECOMMUNICATIONS CORP., LTD., Dongguan (CN)

(72) Inventors: Zixin ZHUANG, Dongguan (CN); Jun ZHANG, Dongguan (CN)

(21) Appl. No.: 19/181,691

(22) Filed: Apr. 17, 2025

Related U.S. Application Data
(63) Continuation of application No. PCT/CN2023/117034, filed on Sep. 5, 2023.

(30) Foreign Application Priority Data
Oct. 17, 2022 (CN) 202211268411.X

(51) Int. Cl. G06F 3/0486; G06F 9/451

(52) U.S. Cl. CPC G06F 3/0486; G06F 9/451

(57) ABSTRACT

Provided are a resource integration method, an electronic device and a storage medium. In the method, a resource list interface and a resource collection interface are displayed. In response to a dragging operation of dragging a target resource of at least one resource from the resource list interface to the resource collection interface, the target resource is displayed on the resource collection interface. An integrated resource is obtained based on the target resource included in the resource collection interface.

### CROSS-REFERENCE OF RELATED APPLICATION

The application is a continuation of International Application No. PCT/CN2023/117034 filed Sep. 5, 2023, which claims priority to Chinese Patent Application No. CN202211268411.X filed Oct. 17, 2022, and the entire disclosures of the above-identified applications are incorporated herein by reference.

### TECHNICAL FIELD

The disclosure relates to the field of electronic devices, and particularly to a resource integration method, an electronic device and a storage medium.

### BACKGROUND

With the development of science and technology, electronic devices are used more and more widely, and have more and more functions. The electronic devices have become one of the necessities in people's daily life. At present, there are more and more resources stored on electronic device.

### SUMMARY

In view of this, the disclosure proposes a resource integration method, a resource integration apparatus, an electronic device and a storage medium.

In a first aspect, embodiments of the disclosure provide a resource integration method. In the method, a resource list interface and a resource collection (i.e., resource organization or resource management) interface are displayed, where the resource list interface includes at least one resource. In response to a dragging operation of dragging a target resource of the at least one resource from the resource list interface to the resource collection interface, the target resource is displayed on the resource collection interface. An integrated resource is obtained based on the target resource included in the resource collection interface.

In a second aspect, the embodiments of the disclosure provide an electronic device. The electronic device includes a memory and a processor. The memory is coupled to the processor, and the memory stores instructions which, when being executed by the processor, cause the processor to execute the above method.

In a third aspect, the embodiments of the disclosure provide a computer-readable storage medium. The storage medium has program codes stored thereon, and the program codes are callable by a processor to execute the above method.

### BRIEF DESCRIPTION OF THE DRAWINGS

In order to more clearly illustrate technical solutions in the embodiments of the disclosure, drawings to be used in the embodiments are briefly described below. Apparently, the following drawings are merely some embodiments of the disclosure, and those skilled in the art can obtain other drawings according to these drawings without paying any creative effort.

FIG. 1 is a schematic structural diagram of an electronic device in a folded state for which a resource integration method according to some embodiments of the disclosure may be applied.

FIG. 2 is a schematic structural diagram of the electronic device in an unfolded state for which the resource integration method according to some embodiments of the disclosure may be applied.

FIG. 3 is a schematic flowchart of a resource integration method according to some embodiment of the disclosure.

FIG. 4 is a schematic flowchart of a resource integration method according to some other embodiment of the disclosure.

FIG. 5 is a schematic flowchart of S220 in the resource integration method illustrated in FIG. 4 of the disclosure.

FIG. 6 is a schematic flowchart of a resource integration method according to still other embodiments of the disclosure.

FIG. 7 is a schematic flowchart of a resource integration method according to yet other embodiments of the disclosure.

FIG. 8 is a schematic flowchart of a resource integration method according to still yet other embodiments of the disclosure.

FIG. 9 is a schematic diagram illustrating a first interface of the electronic device according to some embodiments of the disclosure.

FIG. 10 is a schematic diagram illustrating a second interface of the electronic device according to some embodiments of the disclosure.

FIG. 11 is a schematic diagram illustrating a third interface of the electronic device according to some embodiments of the disclosure.

FIG. 12 is a schematic diagram illustrating a fourth interface of the electronic device according to some embodiments of the disclosure.

FIG. 13 is a schematic diagram illustrating a fifth interface of the electronic device according to some embodiments of the disclosure.

FIG. 14 is a schematic diagram illustrating a sixth interface of the electronic device according to some embodiments of the disclosure.

FIG. 15 is a schematic diagram illustrating a seventh interface of the electronic device according to some embodiments of the disclosure.

FIG. 16 is a schematic diagram illustrating an eighth interface of the electronic device according to some embodiments of the disclosure.

FIG. 17 is a schematic diagram illustrating a ninth interface of the electronic device according to some embodiments of the disclosure.

FIG. 18 is a block diagram of modules of a resource integration apparatus according to some embodiments of the disclosure.

FIG. 19 is a block diagram of an electronic device for executing the resource integration methods according to some embodiments of the disclosure.

FIG. 20 is a diagram of a storage unit for storing or carrying program codes for realizing the resource integration methods according to the embodiments of the disclosure.

### DETAILED DESCRIPTION OF PREFERRED EMBODIMENTS

In order to make those skilled in the art better understand the technical solutions of the disclosure, the technical solutions in the embodiments of the disclosure will be described clearly and comprehensively with reference to the drawings in the embodiments of the disclosure.

At present, more and more resources are stored on electronic devices, but the electronic devices lack management of these resources. In view of this problem, more and more manufacturers have begun to pay attention to the management of these resources, such as automatic tagging and automatic integration of these resources. However, such managements are often inconsistent with users'usage habits or usage needs, resulting in poor user experience.

In view of this, after long-term research, the inventors have discovered and proposed a resource integration method, a resource integration apparatus, an electronic device, and a storage medium according to some embodiments of the disclosure. By providing users with a highly customized file collection and integration method, it provides easy access for users who send and receive resources frequently, thereby improving user experience. The specific resource integration method is described in detail in the subsequent embodiments.

The embodiments of the disclosure provide the resource integration method. The resource list interface and the resource collection interface are displayed, in which the resource list interface includes the at least one resource. In response to the dragging operation of dragging the target resource of the at least one resource from the resource list interface to the resource collection interface, the target resource is displayed on the resource collection interface. The integrated resource is obtained based on the target resource included in the resource collection interface.

According to the embodiments of the disclosure, a thumbnail of the at least one resource is displayed on the resource list interface, and displaying the target resource on the resource collection interface in response to the dragging operation of dragging the target resource of the at least one resource from the resource list interface to the resource collection interface, includes: in response to a dragging operation of dragging a thumbnail of the target resource from the resource list interface to the resource collection interface, displaying the thumbnail of the target resource on the resource collection interface.

According to the embodiments of the disclosure, displaying the thumbnail of the target resource on the resource collection interface in response to the dragging operation of dragging the thumbnail of the target resource from the resource list interface to the resource collection interface, includes: in response to the dragging operation of dragging the thumbnail of the target resource from the resource list interface to the resource collection interface, displaying the thumbnail of the target resource on the resource collection interface, and displaying the thumbnail of the target resource in a target state on the resource list interface, where the target state is configured to indicate that the thumbnail of the target resource has been added to the resource collection interface; or in response to the dragging operation of dragging the thumbnail of the target resource from the resource list interface to the resource collection interface, displaying the thumbnail of the target resource on the resource collection interface, and deleting the thumbnail of the target resource from the resource list interface.

According to the embodiments of the disclosure, after displaying the thumbnail of the target resource on the resource collection interface, the method further includes: in response to a moving operation acting on the thumbnail of the target resource, changing a display position of the thumbnail of the target resource on the resource collection interface.

According to the embodiments of the disclosure, changing the display position of the thumbnail of the target resource on the resource collection interface in response to the moving operation acting on the thumbnail of the target resource, includes: in response to a two-finger dragging operation acting on the thumbnail of the target resource, changing the display position of the thumbnail of the target resource on the resource collection interface.

According to the embodiments of the disclosure, after displaying the thumbnail of the target resource on the resource collection interface, the method further includes: in response to a zooming operation acting on the thumbnail of the target resource, changing a display size of the thumbnail of the target resource on the resource collection interface.

According to the embodiments of the disclosure, changing the display size of the thumbnail of the target resource on the resource collection interface in response to the zooming operation acting on the thumbnail of the target resource, includes: in response to an operation performed with two fingers on the thumbnail of the target resource in which the two fingers slide in opposite directions, scaling up the thumbnail of the target resource on the resource collection interface; or in response to an operation performed with two fingers on the thumbnail of the target resource in which the two fingers slide toward each other, scaling down the thumbnail of the target resource on the resource collection interface.

According to the embodiments of the disclosure, after displaying the thumbnail of the target resource on the resource collection interface, the method further includes: in response to a first touch operation acting on the thumbnail of the target resource, displaying multiple function controls on the resource collection interface; and in response to a second touch operation acting on a target function control of the multiple function controls, performing processing corresponding to the target function control on the target resource.

According to the embodiments of the disclosure, performing the processing corresponding to the target function control on the target resource, includes: in response to the target function control being a delete control, deleting the thumbnail of the target resource from the resource collection interface; or in response to the target function control being a view control, displaying a preview window of the target resource; or in response to the target function control being a share control, sharing the target resource with a to-be-shared object.

According to the embodiments of the disclosure, displaying the target resource on the resource collection interface, includes: displaying the target resource and attribute information of the target resource on the resource collection interface, where the attribute information includes at least one of a name, a type, and a size.

According to the embodiments of the disclosure, after obtaining the integrated resource based on the target resource included in the resource collection interface, the method further includes: displaying multiple sharing channels in response to a sharing operation for the integrated resource; and in response to a third touch operation acting on a target sharing channel of the multiple of sharing channels, sharing the integrated resource to a to-be-shared object through the target sharing channel.

According to the embodiments of the disclosure, after obtaining the integrated resource based on the target resource included in the resource collection interface, the method further includes: displaying multiple sharing manners in response to a sharing operation acting on the integrated resource; and in response to a fourth touch operation acting on a target sharing manner of the multiple sharing manners, sharing the integrated resource to a to-be-shared object through the target sharing manner.

According to the embodiments of the disclosure, displaying the resource list interface and the resource collection interface, includes: displaying the resource list interface and the resource collection interface, where the resource list interface includes at least one resource type control, and each of the at least one resource type control is configured to trigger displaying of at least one resource of a type corresponding to the resource type control; and in response to a fifth touch operation acting on a target resource type control of the at least one resource type control, displaying, on the resource list interface, at least one resource of a type corresponding to the target resource type control on the resource list interface.

According to the embodiments of the disclosure, the method further includes: in response to a target touch operation acting on the resource list interface, switching displaying of the at least one resource on the resource list interface.

According to the embodiments of the disclosure, a scroll bar is displayed on the resource list interface, and switching the displaying of the at least one resource on the resource list interface, includes: in response to a target sliding operation acting on the scroll bar, switching displaying of the at least one resource on the resource list interface.

According to the embodiments of the disclosure, before displaying the target resource on the resource collection interface in response to the dragging operation of dragging the target resource of the at least one resource from the resource list interface to the resource collection interface, the method further includes: in response to detecting a touch operation acting on the resource list interface and a dragging operation performed based on the touch operation, acquiring a touch position corresponding to the touch operation; and determining, from the at least one resource, a resource whose display position of the touch position as the target resource.

According to the embodiments of the disclosure, obtaining the integrated resource based on the target resource included in the resource collection interface, includes: after the target resource is added to the resource collection interface, in response to receiving instruction information indicating confirmation, obtaining the integrated resource based on the target resource included in the resource collection interface.

An application environment in which the resource integration method according to the embodiments of the disclosure is applicable is described as follows.

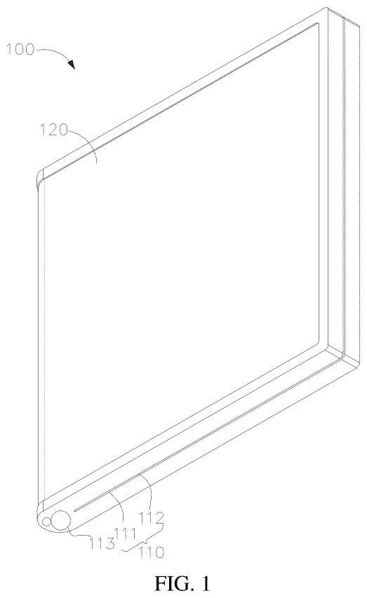

Referring to FIG. 1, the electronic device 100 may be, but is not limited to, a mobile phone, a tablet computer, a game console, a smart wearable device, a vehicle-mounted device, etc. The electronic device 100 of the embodiments is described by taking the mobile phone as an example.

The electronic device 100 includes a foldable housing assembly 110, a flexible display screen 120, and electronic components (not illustrated). The electronic components are provided in the foldable housing assembly 110, and the flexible display screen 120 is laid on the foldable housing assembly 110. The foldable housing assembly 110 is configured to carry the flexible display screen 120 and protect the electronic components. The electronic components may include, but is not limited to, a central processing unit, a memory, a camera, a receiver, a fingerprint module, etc., and the specific electronic component may not be limited in the embodiments of the disclosure.

The foldable housing assembly 110 includes a first housing 111, a second housing 112 and a rotating shaft mechanism 113. The first housing 111 and the second housing 112 are respectively connected to two sides of the rotating shaft mechanism 113. The second housing 112 may be folded or unfolded relative to the first housing 111 via the rotating shaft mechanism 113, so that the foldable housing assembly 110 drives the flexible display screen 120 to be folded or unfolded. When the foldable housing assembly 110 and the flexible display screen 120 are in a folded state, a volume of the electronic device 100 is relatively small, which is convenient for storage and carrying. When the foldable housing assembly 110 and the flexible display screen 120 are in an unfolded state, the volume of the electronic device 100 is relatively large, which is convenient for displaying information.

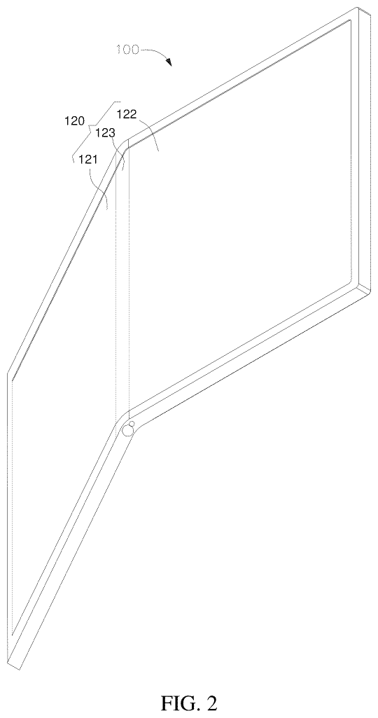

Referring to FIG. 2, in the embodiments, the flexible display screen 120 includes a first display portion (first screen) 121 connected to the first housing 111, a second display portion (second screen) 122 connected to the second housing 112, and a bent display portion 123 connected to the first display portion 121 and the second display portion 122. The first display portion 121, the second display portion 122, and the bent display portion 123 may correspondingly define multiple display areas (such as, two display areas, three display areas, four display areas, . . . , N display areas). The first display portion 121 and the second display portion 122 are relatively folded or unfolded along with the first housing 111 and the second housing 112, respectively. The bent display portion 123 is bent or unfolded with the folded or unfolded state of the first display portion 121 and the second display portion 122. In some embodiments, the first display portion 121, the second display portion 122 and the bent display portion 123 may be integrated, so that the flexible display screen 120 is a one-piece flexible display screen. Alternatively, in some other embodiments, the bent display portion 123 is a flexible portion that is capable of being bent, the first display portion 121 and the second display portion 122 may be non-flexible portions, and the first display portion 121 and the second display portion 122 are folded or unfolded relative to each other via the bent display portion 123. In the embodiments, when the first housing 111 and the second housing 112 are in the folded state, the first display portion 121 and the second display portion 122 face toward opposite sides, so that the electronic device 100 presents a structure of outward-folded screen, which enables the user to observe the display content of the flexible display screen 120 when being folded, thereby improving the convenience of using the electronic device 100. In some other embodiments, when the first housing 111 and the second housing 112 are in the folded state, the first display portion 121 and the second display portion 122 face toward each other, so that the electronic device 100 presents a structure of inward-folded screen, thereby protecting the flexible display screen 120 from scratches and damage.

It should be understood that the naming of the above-mentioned first display portion 121, the second display portion 122 and the bent display portion 123 is only provided for the convenience of description and does not serve as a structural limitation of the flexible display screen 120. In actual application scenarios, there may be no distinct boundary between the first display portion 121, the second display portion 122 and the bent display portion 123. Alternatively, the flexible display screen 120 may be present in other division structures, for example, the flexible display screen 120 includes a first display portion 121 and a second display portion 122 connected to the first display portion 121, and the first display portion 121 and the second display portion 122 are capable of being rotated relative to each other, so as to be folded or unfolded.

Of course, in the embodiments, the electronic device may also be a device without foldable screen, such as a large-screen device, which is not limited here.

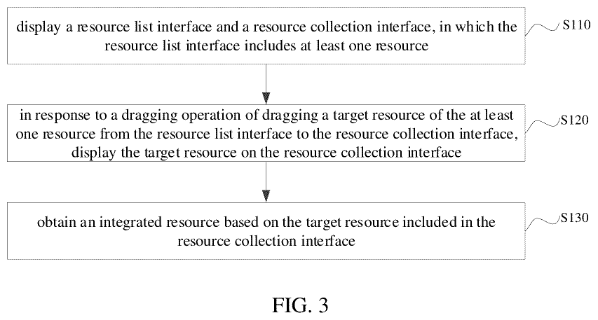

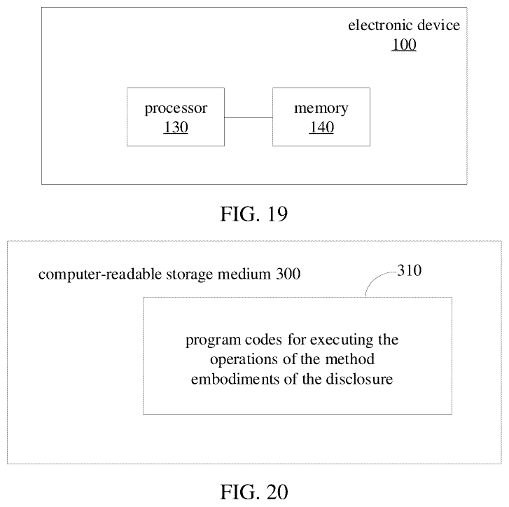

Referring to FIG. 3, FIG. 3 is a schematic flowchart of a resource integration method according to some embodiments of the disclosure. The method is configured to provide users with a highly customized file collection and integration approach, which provides easy access for users who send and receive resources frequently, thereby improving user experience. In a specific embodiment, the resource integration method is implemented by a resource integration apparatus 200 as illustrated in FIG. 18 and an electronic device 100 (as illustrated in FIG. 19) equipped with the resource integration apparatus 200. A specific process of the embodiments will be described below by taking the electronic device as an example. Of course, it can be understood that the electronic device used in the embodiments may include smart phones, tablet computers, wearable electronic devices, etc., which is not limited herein. The process illustrated in FIG. 3 will be described in detail below. The resource integration method may specifically include operations as follows.

At S110, displaying a resource list interface and a resource collection interface, in which the resource list interface includes at least one resource.

In the embodiments, the electronic device may display the resource list interface and the resource collection interface, and the resource list interface includes at least one resource. As a way, the at least one resource may include a picture resource, a video resource, a table resource, a PDF resource, a text document resource, a presentation resource, etc., which is not limited here.

In some embodiments, the electronic device may display the resource list interface and the resource collection interface side by side. For example, the resource list interface and the resource collection interface may be displayed side-by-side in a vertical direction or in a horizontal direction. In a case where the resource list interface and the resource collection interface are displayed side-by-side in the horizontal direction, the resource list interface may be arranged on the left side of the resource collection interface or the right side of the resource collection interface. In a case where the resource list interface and the resource collection interface are displayed side-by-side in the vertical direction, the resource list interface may be arranged above the resource collection interface or below the resource collection interface. This is not limited here.

In some embodiments, an initial display size of the resource list interface may be consistent with an initial display size of the resource collection interface; alternatively, the initial display size of the resource list interface may be inconsistent with the initial display size of the resource collection interface, which is not limited here. While the resource list interface and the resource collection interface are displayed, display sizes of the resource list interface and the resource collection interface may be adjusted and changed as required. As a way, when the display size of the resource list interface is adjusted to decrease, the display size of the resource collection interface may remain unchanged, or may be adjusted to increase accordingly; when the display size of the resource list interface is adjusted to increase, the display size of the resource collection interface may remain unchanged, or may be adjusted to decreased accordingly, which is not limited here. As a way, when the display size of the resource collection interface is adjusted to decrease, the display size of the resource list interface may remain unchanged or may be adjusted to increase accordingly; when the display size of the resource collection interface is adjusted to increase, the display size of the resource list interface may remain unchanged or may be adjusted to decrease accordingly, this is not limited here.

In some embodiments, the at least one resource included in the resource list interface may be displayed on the resource list interface disorderly, or may be displayed on the resource list interface in a regular manner based on different types. As a way, the at least one resource may be switched to be displayed on the resource list interface, based on a target touch operation acting on the resource list interface. For example, a scroll bar may be displayed on the resource list interface, and based on the target sliding operation acting on the scroll bar, the resource list interface is slid to display or hide part of the at least one resource. This is not limited here. As an implementable way, the at least one resource may be presented in a grid-arranged thumbnail plus a respective file name, which is a default display mode, namely “grid arrangement”. A user may choose to display the resource(s) in “grid arrangement” or “list arrangement” by performing a selection operation at the top right of a “File Directory” area.

In some embodiments, the resource collection interface is configured to collect resources that the user wishes to integrate and manage. As a way, the resource collection interface may originally collect an initial resource(s), or may not originally collect an initial resource(s). When the resource collection interface originally collects an initial resource(s), the resource collection interface may display the initial resource(s). When the resource collection interface does not originally collect an initial resource(s), the resource collection interface may not display the initial resource(s), that is, the resource collection interface displays a blank page. As an implementable way, when the resource collection interface originally collects initial resources, the resource collection interface may display the initial resources disorderly, or may display the initial resources according to different types, which is not limited here.

At S120: in response to a dragging operation of dragging a target resource of the at least one resource from the resource list interface to the resource collection interface, displaying the target resource on the resource collection interface.

In the embodiments, while the resource list interface and the resource collection interface are displayed, a dragging operation acting on the resource list interface may be detected. When the dragging operation of dragging the target resource from the resource list interface to the resource collection interface is detected, the target resource may be added to and displayed on the resource collection interface in response to the dragging operation of dragging the target resource from the resource list interface to the resource collection interface. The target resource is one or more of the at least one resource.

In some embodiments, for the at least one resource displayed on the resource list interface, when the user expects to integrate one or more of the at least one resource, the one or more resources may be identified as the target resource, the target resource may be dragged from the resource list interface to the resource collection interface, and the target resource may be displayed on the resource collection interface.

As an implementable way, in response to the dragging operation of dragging the target resource from the resource list interface to the resource collection interface, the target resource may be displayed on the resource collection interface. At this time, the resource list interface may delete the target resource (not display the target resource), may hide the target resource (not display the target resource), may display the target resource with a mark, etc., which is not limited here. Displaying the target resource with a mark is configured to indicate that the target resource already exists in the resource collection interface. As a way, displaying the target resource with a mark includes: displaying the target resource with an identifier added to the target resource, displaying the target resource in grayscale, displaying the target resource with the target resource covered with a check mark, etc., which is not limited here.

In some embodiments, when there is at least one resource displayed on the resource list interface, in response to detecting a touch operation acting on the resource list interface and a dragging operation performed based on the touch operation, a touch position(s) of the touch operation may be acquired, and a resource(s) of the at least one resource whose display position(s) corresponding to the touch position(s) may be determined as the target resource(s).

As a way, one target resource may be determined from the at least one resource each time, and the target resource may be dragged from the resource list interface to the resource collection interface. Based on this, in response to a single-finger or multi-finger touch operation acting on the target resource and a dragging operation performed based on the touch operation, the target resource may be dragged from the resource list interface to the resource collection interface, and the target resource may be displayed on the resource collection interface. When the user expects to integrate multiple resources (more than one resource) of the at least one resource, the user may perform the above operation multiple times.

As an example, one target resource displayed on the resource list interface may be pressed and held with one finger, the target resource is dragged to the resource collection interface and then the dragging operation is released, thereby completing an addition of one target resource into the resource collection interface.

As another way, at least two target resources may be determined from the at least one resource each time, and the at least two target resources may be dragged from the resource list interface to the resource collection interface at the same time. The user may touch different resources with different fingers of multiple fingers, the resources touched by the multiple fingers are determined as the target resources, and then the at least two target resources are determined. Based on this, in response to a touch operation acting on at least two target resources and a dragging operation performed based on the touch operation, the at least two target resources may be dragged from the resource list interface to the resource collection interface at the same time, and the at least two target resources may be displayed on the resource collection interface. In this way, the number of dragging operations can be reduced and the efficiency of resource integration can be improved.

As an example, three target resources displayed on the resource list interface are respectively pressed with three different fingers, and then the three target resources are dragged to the resource collection interface and released, thereby completing an addition of the three target resources into the resource collection interface.

In some implementations, displaying the target resource on the resource collection interface may include: displaying the target resource and attribute information of the target resource on the resource collection interface, in which the attribute information includes at least one of a name, a type, and a size. As an implementable way, the attribute information of the target resource and the target resource may be displayed in an overlapping way, side by side, or the like, which is not limited here.

At S130: obtaining an integrated resource based on the target resource included in the resource collection interface.

In the embodiments, after the target resource is added to the resource collection interface, that is, the target resource is dragged from the resource list interface to the resource collection interface and thus displayed in the resource collection interface, the integrated resource may be obtained based on the target resource included in the resource collection interface, where the integrated resource includes the target resource included in the resource collection interface.

In some embodiments, after the target resource is added to the resource collection interface, it may be detected whether or not instruction information indicating confirmation is received. When it is determined that the instruction information indicating confirmation is received, the integrated resource may be obtained in response to the instruction information, based on the target resource included in the resource collection interface. As a way, the electronic device further displays a “Save” icon button. When a touch operation acting on the “Save” icon button is detected, it may be determined that the instruction information indicating confirmation is received, and the integrated resource may be obtained based on the target resource included in the resource collection interface.

As an implementable way, after the target resource is added to the resource collection interface, a “Collection Package” is in an editing state. When the “Collection Package” is in the editing state, a name in a format of “collection package+number” may be displayed on the top left side of the electronic device, and a position of such characters may be clicked to modify the characters; and a “Save” icon button is displayed on the right side of the electronic device. After a click is performed on the “Save” icon button, the current collection package is saved to obtain the integrated resource, and the editing state is exit to return to a main page of “Collection Package”, where all saved collection packages (integrated resources) are displayed.

In the resource integration method provided according to some embodiments of the disclosure, the resource list interface and the resource collection interface are displayed, in which the resource list interface includes at least one resource. In response to the dragging operation of dragging a target resource of the at least one resource from the resource list interface to the resource collection interface, the target resource is displayed on the resource collection interface. The integrated resource is obtained based on the target resource included in the resource collection interface. In this way, the user is provided with a highly customized file collection and integration method, which provides easy access for the users who send and receive resources frequently, thereby improving the user experience.

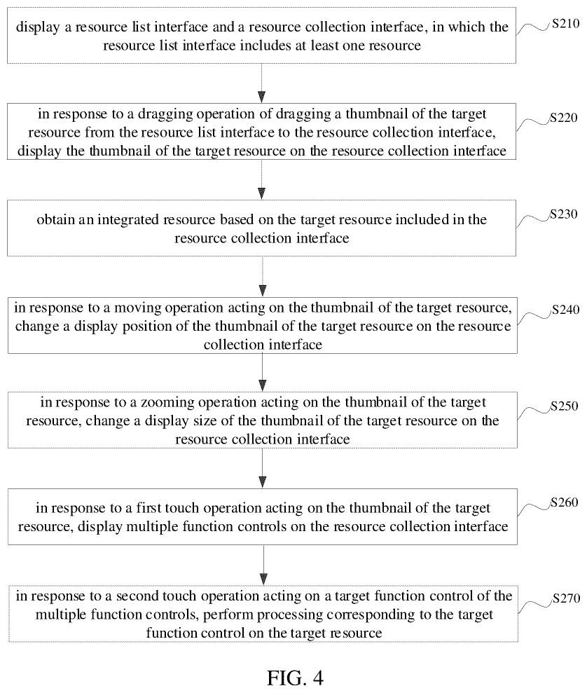

Referring to FIG. 4, FIG. 4 is a schematic flowchart of a resource integration method according to some embodiment of the disclosure. In the embodiments, the at least one resource is displayed on the resource list interface in such a manner that a thumbnail of the at least one resource is displayed on the resource list interface. The process illustrated in FIG. 4 will be described in detail below. The resource integration method may specifically include operations as follows.

At S210, displaying a resource list interface and a resource collection interface, in which the resource list interface includes at least one resource.

For detailed description of S210, reference may be made to S110, which will not be repeated herein.

At S220, in response to a dragging operation of dragging a thumbnail of a target resource from the resource list interface to the resource collection interface, displaying the thumbnail of the target resource on the resource collection interface.

In the embodiments, the at least one resource is displayed on the resource list interface in such a manner that the thumbnail of the at least one resource is displayed on the resource list interface. As a way, each resource may be displayed in such a manner that a thumbnail plus a resource name of the resource are displayed, and the displayed resources are arranged in grid.

In some implementations, while the resource list interface is displayed, a dragging operation acting on the resource list interface may be detected. When the dragging operation of dragging the thumbnail of the target resource from the resource list interface to the resource collection interface is detected, the thumbnail of the target resource may be displayed on the resource collection interface in response to the dragging operation of dragging the thumbnail of the target resource from the resource list interface to the resource collection interface. As an implementable way, displaying the thumbnail of the target resource on the resource collection interface may include: displaying the thumbnail of the target resource and attribute information of the target resource on the resource collection interface.

In some implementations, a display size of the thumbnail of the target resource in the resource list interface may be the same as or different from a display size of the thumbnail of the target resource in the resource collection interface. When the display size of the thumbnail of the target resource in the resource list interface is the same as the display size of the thumbnail of the target resource in the resource collection interface, it indicates that dragging the thumbnail of the target resource from the resource list interface to the resource collection interface does not affect the display size of the thumbnail of the target resource, and such display size remains unchanged. When the display size of the thumbnail of the target resource in the resource list interface is different from the display size of the thumbnail of the target resource in the resource collection interface, it indicates that dragging the thumbnail of the target resource from the resource list interface to the resource collection interface affects the display size of the thumbnail of the target resource, and such display size may be enlarged or reduced, which is not limited here.

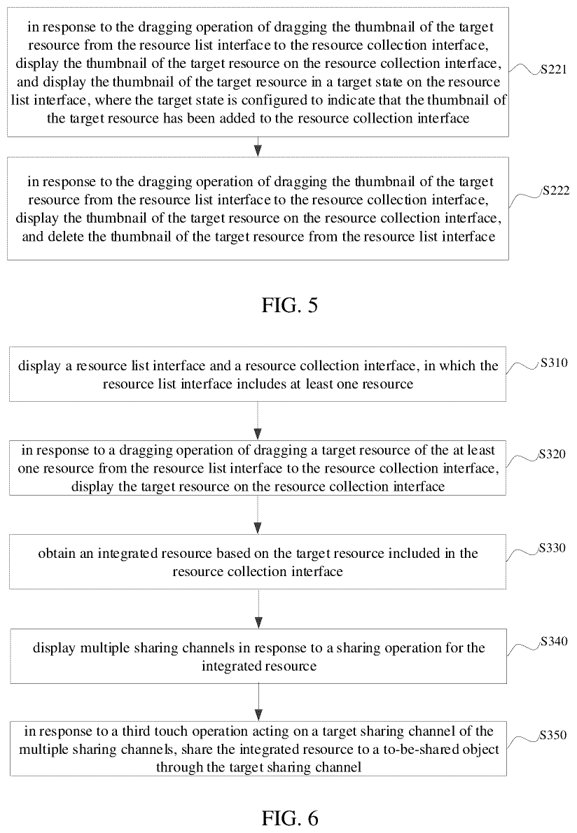

Referring to FIG. 5, FIG. 5 is a schematic flowchart of S220 in the resource integration method illustrated in FIG. 4 of the disclosure. Details for the process illustrated in FIG. 5 will be provided below, the method may specifically include operations as follows.

At S221, in response to the dragging operation of dragging the thumbnail of the target resource from the resource list interface to the resource collection interface, displaying the thumbnail of the target resource on the resource collection interface, and displaying the thumbnail of the target resource in a target state on the resource list interface, where the target state is configured to indicate that the thumbnail of the target resource has been added to the resource collection interface.

In the embodiments, after the thumbnail of the target resource is dragged from the resource list interface to the resource collection interface, the thumbnail of the target resource may be displayed on both the resource list interface and the resource collection interface. In some implementations, in response to the dragging operation of dragging the thumbnail of the target resource from the resource list interface to the resource collection interface, the thumbnail of the target resource may be displayed on the resource collection interface, and the thumbnail of the target resource may be displayed in the target state on the resource list interface, where the target state is configured to indicate that the thumbnail of the target resource has been added to the resource collection interface.

In some implementations, displaying the thumbnail of the target resource in the target state on the resource list interface may include: reducing an opacity of the thumbnail of the at least one resource except the target resource in the resource list interface to a preset ratio (such as 30%), and not underlining the at least one resource except the target resource.

At S222, in response to the dragging operation of dragging the thumbnail of the target resource from the resource list interface to the resource collection interface, displaying the thumbnail of the target resource on the resource collection interface, and deleting the thumbnail of the target resource from the resource list interface.

In the embodiments, after the thumbnail of the target resource is dragged from the resource list interface to the resource collection interface, the thumbnail of the target resource may be displayed only on the resource collection interface. As an implementable way, in response to the dragging operation of dragging the thumbnail of the target resource from the resource list interface to the resource collection interface, the thumbnail of the target resource may be displayed on the resource collection interface, and the thumbnail of the target resource may be deleted from the resource list interface.

In some implementations, after the thumbnail of the target resource is deleted from the resource collection interface, the resource list interface may redisplay the thumbnail of the target resource.

At S230: obtaining an integrated resource based on the target resource included in the resource collection interface.

For detailed description of S230, reference may be made to S130, which not be repeated herein.

At S240: in response to a moving operation acting on the thumbnail of the target resource, changing a display position of the thumbnail of the target resource on the resource collection interface.

In the embodiments, when the thumbnail of the target resource is displayed on the resource collection interface, an operation acting on the thumbnail of the target resource may be detected. When the moving operation acting on the thumbnail of the target resource is detected, the display position of the thumbnail of the target resource on the resource collection interface may be changed in response to the moving operation acting on the thumbnail of the target resource. Based on this, the user may change, through the moving operation acting on the thumbnail of the target resource, the display position of the thumbnail of the target resource in the resource collection interface as required, thereby improving the user's usage experience and interaction experience.

In some implementations, the moving operation acting on the thumbnail of the target resource may include: dragging the thumbnail of the target resource with two fingers, so as to move the thumbnail of the target resource within an area of the resource collection interface.

At S250, in response to a zooming operation acting on the thumbnail of the target resource, changing a display size of the thumbnail of the target resource on the resource collection interface.

In the embodiments, when the thumbnail of the target resource is displayed on the resource collection interface, an operation acting on the thumbnail of the target resource may be detected. When the zooming operation acting on the thumbnail of the target resource is detected, the display size of the thumbnail of the target resource on the resource collection interface is changed in response to the zooming operation acting on the thumbnail of the target resource. That is, the display size of the thumbnail of the target resource on the resource collection interface may be increased, or decreased.

In some implementations, the zooming operation acting on the thumbnail of the target resource may include: an operation performed with two fingers on the thumbnail of the target resource in which the two fingers slide in opposite direction, for scaling up such thumbnail, or an operation performed with two fingers on the thumbnail of the target resource in which the two fingers slide toward each other, for scaling down such thumbnail.

At S260, in response to a first touch operation acting on the thumbnail of the target resource, displaying multiple function controls on the resource collection interface.

In the embodiments, when the thumbnail of the target resource is displayed on the resource collection interface, an operation acting on the thumbnail of the target resource may be detected. When the first touch operation acting on the thumbnail of the target resource is detected, the multiple function controls are displayed on the resource collection interface in response to the first touch operation acting on the thumbnail of the target resource.

In some implementations, the first touch operation acting on the thumbnail of the target resource may include: a single-finger click operation, a double-finger click operation, a multi-finger click operation, a single-finger press operation, a double-finger press operation, a multi-finger press operation, a single-finger long press operation, a double-finger long press operation, and a multiple-finger long press operation, which is not limited here.

In some embodiments, displaying the multiple function controls on the resource collection interface may include: displaying the thumbnail of the target resource and the multiple function controls side by side on the resource collection interface; or, displaying the thumbnail of the target resource on the resource collection interface and superimposing the multiple function controls on the thumbnail of the target resource.

At S270, in response to a second touch operation acting on a target function control of the multiple function controls, performing processing corresponding to the target function control on the target resource.

In the embodiments, while the multiple function controls are displayed on the resource collection interface, an operation acting on the multiple function controls may be detected. When the second touch operation acting on a target function control of the multiple function controls is detected, the target resource is processed accordingly in response to the second touch operation acting on the target function control of the multiple function controls. The target function control may be any one of the multiple function controls.

In some implementations, the second touch operation acting on the target function control may include: a single-finger click operation, a double-finger click operation, a multi-finger click operation, a single-finger press operation, a double-finger press operation, a multi-finger press operation, a single-finger long press operation, a double-finger long press operation, and a multiple-finger long press operation, which is not limited here.

As an implementable way, the multiple function controls may include a delete control, a view control, and a share control. When the target function control is the delete control, the thumbnail of the target resource may be deleted from the resource collection interface, and accordingly, the resource list interface resumes displaying the thumbnail of the target resource normally, and a source file of the target resource is not deleted from the electronic device. When the target function control is the view control, a preview window of the target resource may be displayed (a resource in a compressed package format cannot be previewed in the preview window). When the target function control is the share control, the target resource may be shared to a to-be-shared object.

In the resource integration method provided in the embodiments of the disclosure, the resource list interface and the resource collection interface are displayed, in which the resource list interface includes the thumbnail of the at least one resource. In response to the dragging operation of dragging the thumbnail of the target resource of the at least one resource from the resource list interface to the resource collection interface, the thumbnail of the target resource is displayed on the resource collection interface. The integrated resource is obtained based on the target resource included in the resource collection interface. In response to the moving operation acting on the thumbnail of the target resource, the display position of the thumbnail of the target resource is changed in the resource collection interface. Alternatively, in response to the zooming operation acting on the thumbnail of the target resource, the display size of the thumbnail of the target resource is changed in the resource collection interface. Alternatively, in response to the first touch operation acting on the thumbnail of the target resource, the multiple function controls are displayed in the resource collection interface. In response to the second touch operation acting on the target function control of the multiple function controls, the target resource is processed accordingly. Compared with the resource integration method illustrated in FIG. 3, in such embodiments, the resources are further displayed in the form of the thumbnails thereof, and the display positions, display sizes, etc. of the thumbnails of the resources may be changed, thereby improving the user's interactive experience.

Referring to FIG. 6, FIG. 6 is a schematic flowchart of a resource integration method according to still other embodiments of the disclosure. The process illustrated in FIG. 6 will be described in detail below. The resource integration method may specifically include operations as follows.

At S310, displaying a resource list interface and a resource collection interface, in which the resource list interface includes at least one resource.

At S320: in response to a dragging operation of dragging a target resource of the at least one resource from the resource list interface to the resource collection interface, displaying the target resource on the resource collection interface.

At S330: obtaining an integrated resource based on the target resource included in the resource collection interface.

For detailed description of S310 to S330, reference may be made to S110 to S130, which will not be repeated herein.

At S340, displaying multiple sharing channels in response to a sharing operation for the integrated resource.

In the embodiments, after the integrated resource is obtained, an operation acting on the integrated resource may be detected. When the sharing operation for the integrated resource is detected, the multiple sharing channels may be displayed in response to the sharing operation for the integrated resource. The integrated resource may be shared to a to-be-shared object through any of the multiple sharing channels, and each of the multiple sharing channels is configured to share the integrated resource to the to-be-shared object through a different channel.

As an implementable way, with regard to the sharing operation for the integrated resource, when a duration of pressing the integrated resource (collection package) reaches a time threshold, an operable menu bar may be displayed at the bottom of the page, a sharing window pops up upon selection of a “Share” control in the operable menu bar, and a thumbnail and a name of the integrated resource may be displayed in the sharing window. In addition, the multiple sharing channels may be displayed in the sharing window.

As an implementable way, the multiple sharing channels may include: sending to friends via WeChat, sending to friends via QQ, sending to friends via email, uploading to a cloud disk (system), etc., which is not limited here.

At S350, in response to a third touch operation acting on a target sharing channel of the multiple sharing channels, sharing the integrated resource to a to-be-shared object through the target sharing channel.

In the embodiments, while the multiple sharing channels are displayed, an operation acting on the multiple sharing channels may be detected. When the third touch operation acting on the target sharing channel of the multiple sharing channels is detected, the integrated resource may be shared to the to-be-shared object through the target sharing channel, in response to the third touch operation acting on the target sharing channel of the multiple sharing channels. The target sharing channel may be any one of the multiple sharing channels.

In some implementations, the third touch operation acting on the target sharing channel may include: a single-finger click operation, a double-finger click operation, a multi-finger click operation, a single-finger press operation, a double-finger press operation, a multi-finger press operation, a single-finger long press operation, a double-finger long press operation, and a multiple-finger long press operation, which is not limited here.

The target resource added to the integrated resources does not change an actual resource path, but provides a quick channel to open various resources in the electronic device. Only when the integrated resource is shared, the target resource is copied to the integrated resources and sent.

In the resource integration method provided in the embodiments of the disclosure, the resource list interface and the resource collection interface are displayed, in which the resource list interface includes at least one resource. In response to the dragging operation of dragging the target resource of the at least one resource from the resource list interface to the resource collection interface, the target resource is displayed on the resource collection interface. The integrated resource is obtained based on the target resource included in the resource collection interface. The multiple sharing channels are displayed in response to the sharing operation for the integrated resource. In response to the third touch operation acting on the target sharing channel of the multiple sharing channels, the integrated resource is shared to the to-be-shared object through the target sharing channel. Compared with the resource integration method illustrated in FIG. 3, in such embodiments, the integrated resource may further be shared through different sharing channels, which can enhance the user's sharing experience.

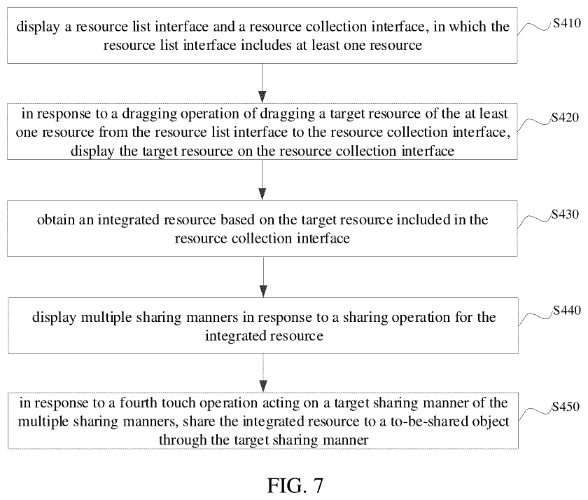

Referring to FIG. 7, FIG. 7 is a schematic flowchart of a resource integration method according to still other embodiments of the disclosure. The process illustrated in FIG. 7 will be described in detail below. The resource integration method may specifically include operations as follows.

At S410, displaying a resource list interface and a resource collection interface, in which the resource list interface includes at least one resource.

At S420: in response to a dragging operation of dragging a target resource of the at least one resource from the resource list interface to the resource collection interface, displaying the target resource on the resource collection interface.

At S430: obtaining an integrated resource based on the target resource included in the resource collection interface.

For detailed description of S410 to S430, reference may be made to S110 to S130, which will not be repeated herein.

At S440, displaying multiple sharing manners in response to a sharing operation for the integrated resource.

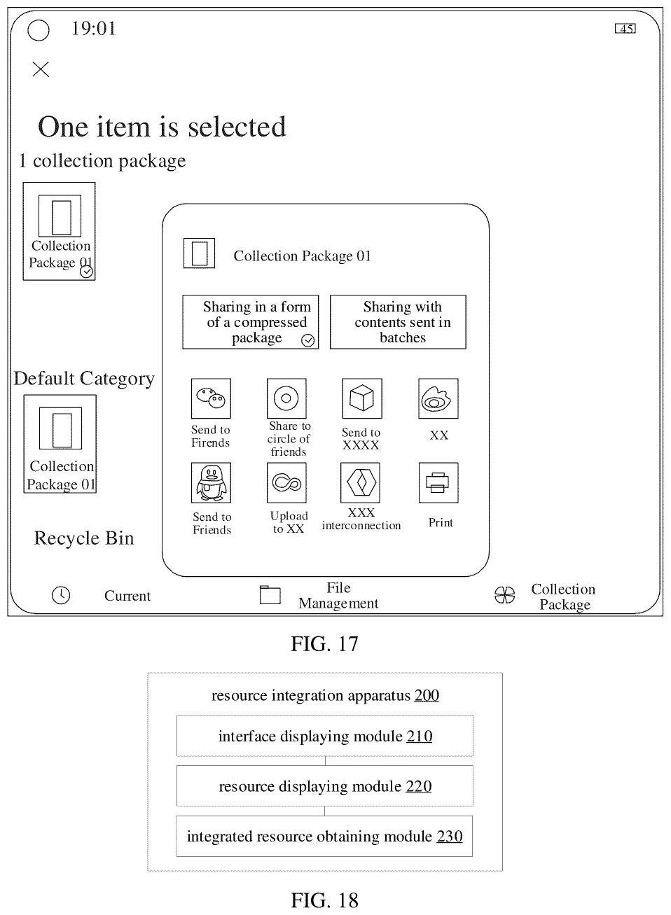

In the embodiments, after the integrated resource is obtained, an operation acting on the integrated resource may be detected. When the sharing operation for the integrated resource is detected, the multiple sharing manners may be displayed in response to the sharing operation for the integrated resource. In some embodiments, as illustrated in FIG. 17, in response to the sharing operation for the integrated resource, both of the sharing manners and the sharing channels may be displayed, that is, the embodiments illustrated in FIG. 6 and FIG. 7 may be combined. The integrated resource may be shared to a to-be-shared object through any of the multiple sharing manners, and each of the multiple sharing manners is configured to share the integrated resource to the to-be-shared object through a different way.

As an implementable way, with regard to the sharing operation for the integrated resource, when a duration of pressing the integrated resource (collection package) reaches a time threshold, an operable menu bar may be displayed at the bottom of the page, a sharing window pops up upon selection of a “Share” control in the operable menu bar, and a thumbnail and a name of the integrated resource may be displayed in the sharing window. In addition, the multiple sharing manners may be displayed in the sharing window.

As an implementable way, the multiple sharing manners may include: sharing a resource in a form of a compressed package, sharing a resource with the content thereof sent in batches, etc., which are not limited here. Sharing the resource in the form of the compressed package means sharing the resource to the to-be-shared object in a default compressed file format, and sharing the source with the content thereof sent in batches means sharing all resource contents in the integrated resource in their respective file formats in sequence to the to-be-shared object.

At S450, in response to a fourth touch operation acting on a target sharing manner of the multiple sharing manners, sharing the integrated resource to a to-be-shared object through the target sharing manner.

In the embodiments, while the multiple sharing manners are displayed, an operation acting on the multiple sharing manners may be detected. When the fourth touch operation acting on the target sharing manner of the multiple sharing manners is detected, the integrated resource may be shared to the to-be-shared object through the target sharing manner, in response to the fourth touch operation acting on the target sharing manner of the multiple sharing manners. The target sharing manner may be any one of the multiple sharing manners.

In some implementations, the fourth operation acting on the target sharing manner may include: a single-finger click operation, a double-finger click operation, a multi-finger click operation, a single-finger press operation, a double-finger press operation, a multi-finger press operation, a single-finger long press operation, a double-finger long press operation, and a multiple long-finger press operation, which is not limited here.

In the resource integration method provided in the embodiments of the disclosure, the resource list interface and the resource collection interface are displayed, in which the resource list interface includes at least one resource. In response to the dragging operation of dragging the target resource of the at least one resource from the resource list interface to the resource collection interface, the target resource is displayed on the resource collection interface. The integrated resource is obtained based on the target resource included in the resource collection interface. The multiple sharing manners are displayed in response to the sharing operation for the integrated resource. In response to the fourth touch operation acting on the target sharing manner of the multiple sharing manners, the integrated resource is shared to the to-be-shared object through the target sharing manner. Compared with the resource integration method illustrated in FIG. 3, in such embodiments, the integrated resource may further be shared through different sharing manners, which can enhance the user's sharing experience.

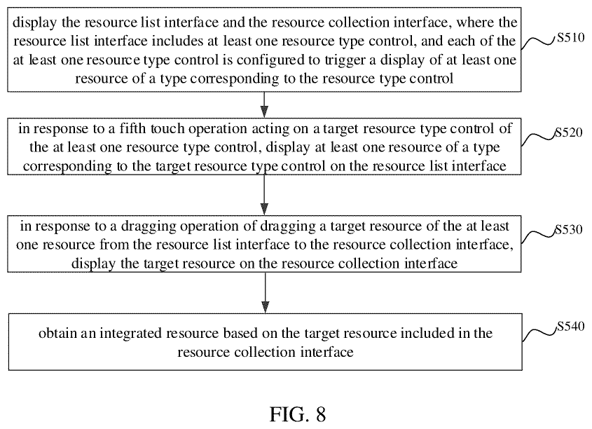

Referring to FIG. 8, FIG. 8 is a schematic flowchart of a resource integration method according to still yet other embodiments of the disclosure. The process illustrated in FIG. 8 will be described in detail below. The resource integration method may specifically include operations as follows.

At S510, displaying the resource list interface and the resource collection interface, where the resource list interface includes at least one resource type control, and each of the at least one resource type control is configured to trigger displaying of at least one resource of a type corresponding to the resource type control.

In the embodiments, the resource list interface may include the at least one resource type control, and each of the at least one resource type control is configured to trigger the displaying of at least one resource of the type corresponding to the resource type control. The at least one resource type control may include: a picture type control, a video type control, an audio type control, a table type control, a PDF type control, a text document type control, a presentation type control, a work type control, a personal type control, etc., which are not limited here.

In some embodiments, a button named “Collection Package” may be found at the bottom of a “File Management” application of the electronic device, and the “Collection Package” button may be clicked to enter a “Collection Package” tab in the application. Only files of a “Collection Package” type are displayed on this functional main page, and such files are displayed in a customized category (which refers to a category of the collection package created by the user on this page, multiple collection packages may be selected and moved to this category. When no category is established in advance, only a “Default Category” is displayed on a main page of “Collection Package”) and a “Recycle Bin” category (which displays files of collection packages that have been deleted within the last month and such deleted files may be recovered from here).

Upon a click on a “New (collection package)” button on the main page of “Collection Package”, this page jumps to an editing state, in which a “collection board (a resource collection interface)” is displayed in gray on the right, with a semi-transparent text prompt “Please add a file” being displayed thereon; and an “Add File” button is displayed in a left prompt area. In response to a click on the “Add File” button on the left, this area expands horizontally to form an area close to 1:1 in size of the “collection board” area on the right, and the expanded area is displayed as a “File Directory (resource list interface)”.

In some embodiments, when the resource list interface is accessed, the “File Directory” may be displayed in the resource list interface, and at least one resource type control is obtained through first-level classification in a default file classification manner in the “File Management” application of the electronic device, and the category of the at least one resource type control is displayed as an corresponding icon plus text, such as a “Picture” type control, a “Video” type control, an “Audio” type control and other icons, as well as respective texts. In order to facilitate the user to perform an accurate file indexing, various types of commonly used file types may be added under the first-level classification, such as a “Table” type control, a “PDF” type control, a “Text document” type control, a “Presentation” type control, and resource collections that may be built by the user, such as a “Work” type control, a “Personal” type control.

At S520: in response to a fifth touch operation acting on a target resource type control of the at least one resource type control, displaying at least one resource of a type corresponding to the target resource type control on the resource list interface.

In the embodiments, while the resource list interface (including the at least one resource type control) and the resource collection interface are displayed, an operation acting on the resource list interface may be detected. When the fifth touch operation acting on the target resource control in the at least one resource type control is detected, the at least one resource of the type corresponding to the target resource type control may be displayed on the resource list interface, in response to the fifth touch operation acting on the target resource control. The target resource type control is one or more resource type controls in the at least one resource type control.

In some implementations, the fifth touch operation acting on the target resource type may include: a single-finger click operation, a double-finger click operation, a multi-finger click operation, a single-finger press operation, a double-finger press operation, a multi-finger press operation, a single-finger long press operation, a double-finger long press operation, and multiple long press operations, which is not limited here.

For example, assuming that the target resource type control is “Picture”, multiple pictures may be displayed on the resource list interface; and assuming that the target resource type control is “Table”, multiple tables may be displayed on the resource list interface.

As an implementable way, in response to a click acting on the target resource type control in the at least one resource type control under the first-level classification, second-level classification is expanded below the target resource type control, and an opacity of the remaining unselected resource type control in the first-level classification is reduced to 50%. In the second-level classification, all resources under the resource type control are classified based on resource sources, and the categories are displayed as text, such as “All”, “Album”, and “WeChat”. Under the second-level classification, the resources are displayed in the form of the thumbnails plus the names thereof.

At S530: in response to a dragging operation of dragging a target resource of the at least one resource from the resource list interface to the resource collection interface, displaying the target resource on the resource collection interface.

At S540: obtaining an integrated resource based on the target resource included in the resource collection interface.

For detailed description of S530 to S540, reference may be made to S120 to S130, which will not be repeated herein.

In the resource integration method provided in the embodiments of the disclosure, the resource list interface and the resource collection interface are displayed, where the resource list interface includes the at least one resource type control, and each of the at least one resource type control is configured to trigger the displaying of at least one resource of the type corresponding to the resource type control. In response to the fifth touch operation acting on the target resource type control of the at least one resource type control, the at least one resource of a type corresponding to the target resource type control is displayed on the resource list interface. In response to the dragging operation of dragging the target resource of the at least one resource from the resource list interface to the resource collection interface, the target resource is displayed on the resource collection interface. The integrated resource is obtained based on the target resource included in the resource collection interface. Compared with the resource integration method illustrated in FIG. 3, these embodiments enable different types of resources to be selected through the resource type control, thereby realizing the integration of different types of resources, which can improve the experience of resource integration.

The following is an explanation of an example of the resource integration method according to the embodiments of the disclosure.

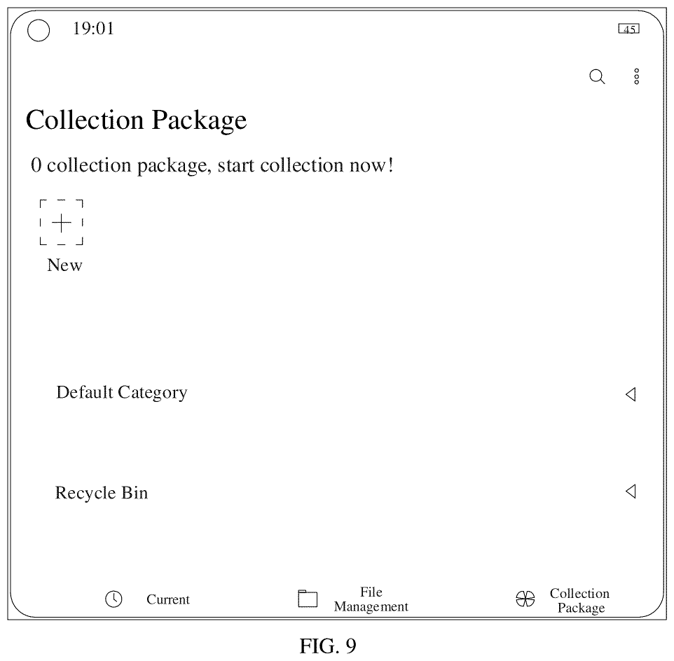

Find the “Collection Package” tab at the bottom of the “File Management” application of the electronic device to enter the collection package page (as illustrated in FIG. 9), where the collection package page displays the “New” button, the “Default Category” button, and the “Recycle Bin” button.

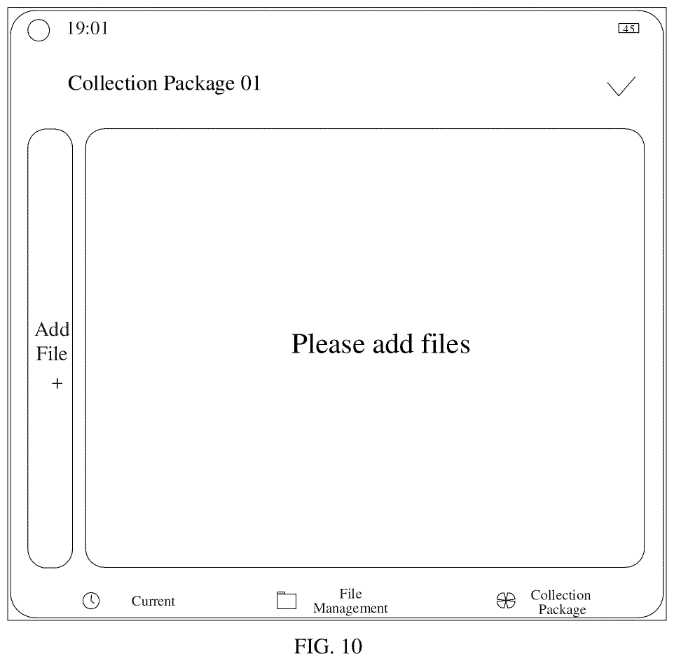

Upon a click on the “New” button on the collection package main page, the collection board (the resource collection interface) is displayed on the right side of the page, with a translucent text prompt “Please add files” displayed on the collection board, and the “Add File” button is displayed on the left side of the page (as illustrated in FIG. 10).

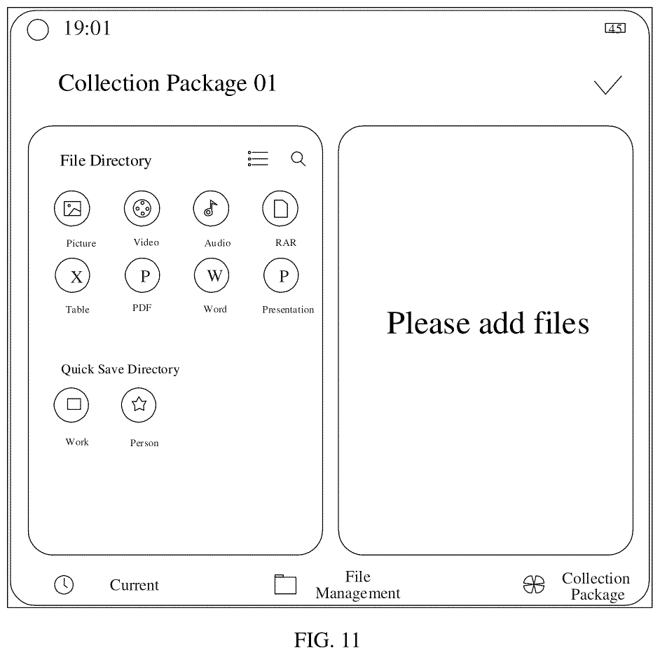

In response to a click on the “Add File” button, this area expands (the expanded area is the resource list interface). The expanded area is classified based on the default file type (at least one resource type control is displayed), and a category of quick save is displayed separately below (as illustrated in FIG. 11).

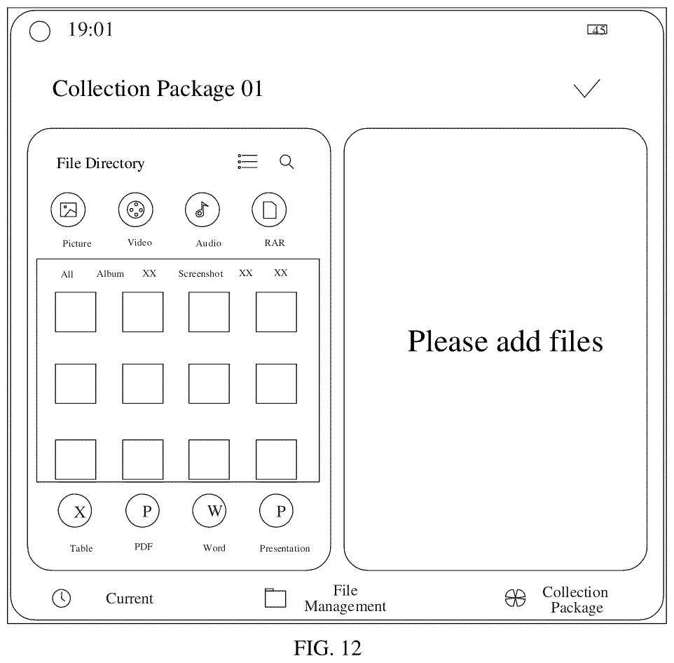

After selecting a desired file type (the target resource type control), the second-level classification and the thumbnail of the at least one resource are displayed (as illustrated in FIG. 12).

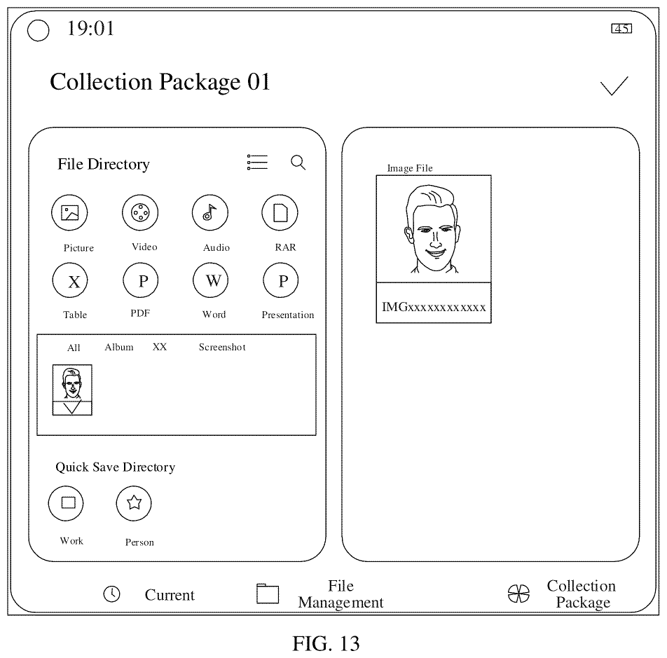

While the resource list interface (including the at least one resource) and the resource collection interface (the collection board) are displayed, the required resource is dragged to the collection board on the right, and a preview image (the thumbnail of the target resource) is presented. At the same time, the resource in the file directory on the left is displayed as “Added” (as illustrated in FIG. 13).

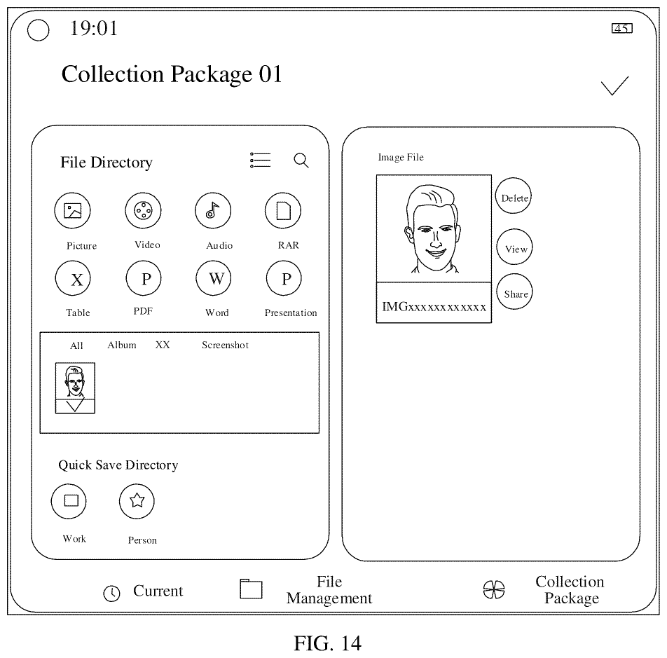

In response to a click on the preview image in the collection board, the “Delete” function control, the “View” function control, and the “Share” function control appear (as illustrated in FIG. 14).

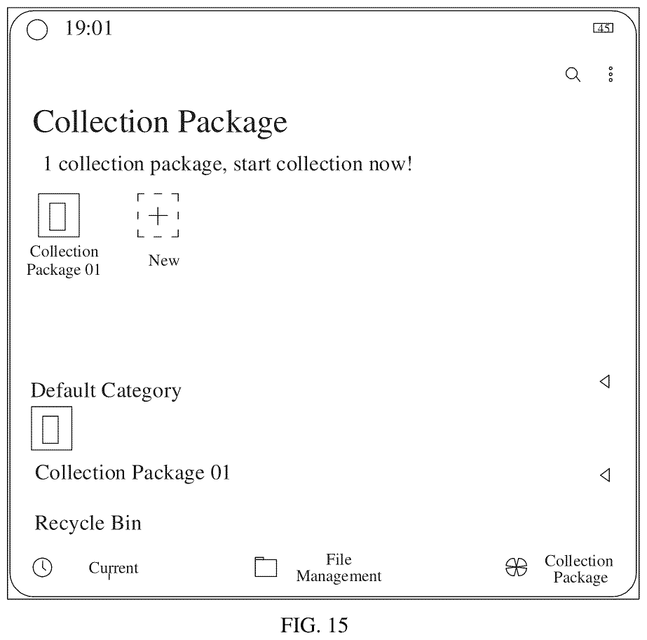

The name of the collection package (the integrated resource) may be changed through an operation on the upper left corner, and the collection package may be saved through an operation on the upper right corner. After saving the collection package, it returns to the storage package main page (as illustrated in FIG. 15).

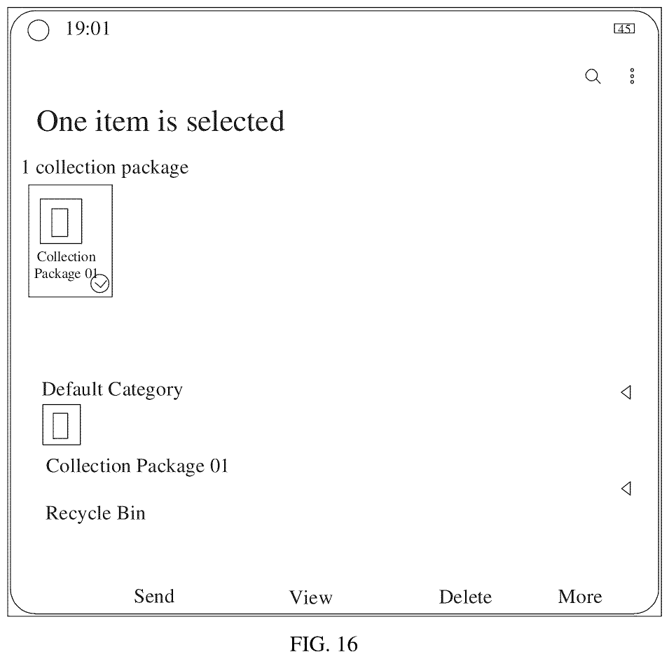

In response to a long press acting on the collection package, the collection package is selected. Upon the selection, functions such as “Send” are enabled. The “More” tab enables to add a shortcut to the collection package to the desktop (as illustrated in FIG. 16).

After selecting “Send”, a channel and a manner to send the resource may be selected (as illustrated in FIG. 17).

Referring to FIG. 18, FIG. 18 is a block diagram of modules of a resource integration apparatus according to some embodiments of the disclosure. The block diagram illustrated in FIG. 18 will be described. The resource integration apparatus 200 includes: an interface displaying module 210, a resource displaying module 220, and an integrated resource obtaining module 230.

The interface displaying module 210 is configured to display a resource list interface and a resource collection interface, where the resource list interface includes at least one resource.

Furthermore, the interface displaying module 210 includes: an interface displaying submodule and a resource displaying submodule.

The interface displaying submodule is configured to display the resource list interface and the resource collection interface, where the resource list interface includes at least one resource type control, and each of the at least one resource type control is configured to trigger displaying of at least one resource of a type corresponding to the resource type control.

The resource displaying submodule is configured to, in response to a fifth touch operation acting on a target resource type control of the at least one resource type control, display, on the resource list interface at least one resource of a type corresponding to the target resource type control on the resource list interface.

The resource displaying module 220 is configured to in response to a dragging operation of dragging a target resource of the at least one resource from the resource list interface to the resource collection interface, display the target resource on the resource collection interface.

Furthermore, a thumbnail of the at least one resource is displayed on the resource list interface, and the resource displaying module 220 includes: a thumbnail displaying submodule.

The thumbnail displaying submodule is configured to, in response to a dragging operation of dragging a thumbnail of the target resource from the resource list interface to the resource collection interface, display the thumbnail of the target resource on the resource collection interface.

Furthermore, the thumbnail displaying submodule includes: a first thumbnail displaying submodule and a second thumbnail displaying submodule.

The first thumbnail displaying submodule is configured to, in response to the dragging operation of dragging the thumbnail of the target resource from the resource list interface to the resource collection interface, display the thumbnail of the target resource on the resource collection interface, and display the thumbnail of the target resource in a target state on the resource list interface, where the target state is configured to indicate that the thumbnail of the target resource has been added to the resource collection interface.

The second thumbnail displaying submodule is configured to, in response to the dragging operation of dragging the thumbnail of the target resource from the resource list interface to the resource collection interface, display the thumbnail of the target resource on the resource collection interface, and delete the thumbnail of the target resource from the resource list interface.

Furthermore, the resource displaying module 220 includes: a display position changing submodule.

The display position changing submodule is configured to, in response to a moving operation acting on the thumbnail of the target resource, change a display position of the thumbnail of the target resource on the resource collection interface.

Furthermore, the resource displaying module 220 includes: a display size changing submodule.

The display size changing submodule is configured to, in response to a zooming operation acting on the thumbnail of the target resource, change a display size of the thumbnail of the target resource on the resource collection interface.

Furthermore, the resource displaying module 220 includes: a function control displaying submodule and a resource processing submodule.

The function control displaying submodule is configured to, in response to a first touch operation acting on the thumbnail of the target resource, display multiple function controls on the resource collection interface.

The resource processing submodule is configured to, in response to a second touch operation acting on a target function control of the multiple function controls, perform processing corresponding to the target function control on the target resource.

Furthermore, the resource processing submodule includes: a resource deleting unit, a resource viewing unit and a resource sharing unit.

The resource deleting unit is configured to, in response to the target function control being a delete control, delete the thumbnail of the target resource from the resource collection interface; or

The resource viewing unit is configured to, in response to the target function control being a view control, display a preview window of the target resource; or

The resource sharing unit is configured to, in response to the target function control being a share control, share the target resource with a to-be-shared object.

Furthermore, the resource displaying module 220 includes: an attribute information displaying submodule.

The attribute information displaying submodule is configured to display the target resource and attribute information of the target resource on the resource collection interface, where the attribute information includes at least one of a name, a type, and a size.

The integrated resource obtaining module 230 is configured to obtain an integrated resource based on the target resource included in the resource collection interface.

Furthermore, the resource integration apparatus 200 includes: a sharing channel displaying module and a first resource sharing module.

The sharing channel displaying module is configured to display multiple sharing channels in response to a sharing operation for the integrated resource.

The first resource sharing module is configured to, in response to a third touch operation acting on a target sharing channel of the multiple sharing channels, share the integrated resource to a to-be-shared object through the target sharing channel.

Furthermore, the resource integration apparatus 200 includes: a sharing manner displaying module and a second resource sharing module.

The sharing manner displaying module is configured to display multiple sharing manners in response to a sharing operation for the integrated resource.

The second resource sharing module is configured to, in response to a fourth touch operation acting on a target sharing manner of the multiple sharing manners, share the integrated resource to a to-be-shared object through the target sharing manner.

Those skilled in the art will clearly appreciate that, for the convenience and simplicity of the description, the specific operation processes of the above apparatus and modules can be referred to the corresponding processes in the above method embodiments and will not be repeated herein.

In the exemplary embodiments provided in the disclosure, a coupling between the modules may be electrical, mechanical, or in other forms.

In addition, various functional modules in the various exemplary embodiments of the disclosure may be integrated in one processing module, or each module may physically exist separately, or two or more modules may be integrated in a single module. The above integrated modules may be implemented either in the form of hardware or in the form of software functional modules.

Referring to FIG. 19, FIG. 19 is a block diagram of an electronic device for executing the resource integration method according to some embodiments of the disclosure. The electronic device 100 may be an electronic device capable of running applications, such as a smart phone, a tablet computer, an e-book. The electronic device 100 in the disclosure may include one or more of the following components: a processor 110, a memory 120, and one or more applications. The one or more applications may be stored in the memory 120 and configured to be executed by the one or more processors 110, and the one or more programs are configured to execute the method described in the aforementioned method embodiments.

The processor 110 may include one or more processing cores. The processor 110 may be connected to various parts of the entire electronic device 100 by using various interfaces and lines, and execute various functions of the electronic device 100 and process data by running or executing instructions, programs, code sets, or instruction sets stored in the memory 120, and calling data stored in the memory 120. In some implementations, the processor 110 may be implemented in at least one hardware of a digital signal processing (DSP), a field-programmable gate array (FPGA), and a programmable logic array (PLA). The processor 110 may integrate one or more of a central processing unit (CPU), a graphics processing unit (GPU), and a modem. The CPU mainly handles an operating system, a user interface, an application, or the like. The GPU is configured to render and draw the content required to be displayed by the display screen. The modem is configured to handle a wireless communication. It can be understood that the modem may also not be integrated into the processor 110 and be realized by a single chip.

The memory 110 may include a random access memory (RAM), and may also include a read-only memory (ROM). The memory 120 may be configured to store instructions, programs, codes, code sets, or instruction sets. The memory 120 may include a program storage area and a data storage area. The program storage area may store instructions for implementing the operating system, instructions for realizing at least one function (such as a touch control function, a voice playing function, and an image playing function), instructions for implementing the following method embodiments, etc. The data storage area may store data (e.g., phone book, audio/video data, chat log data) and the like created by the electronic device 100 during use.

Referring to FIG. 20, FIG. 20 illustrates a structural block diagram of a computer-readable storage medium according to the embodiments of the disclosure. The computer-readable medium 300 stores program codes therein, which may be called by a processor to execute the method described in the above method embodiments.

The computer-readable storage medium 300 may be an electronic memory such as a flash memory, electrically erasable programmable read-only memory (EEPROM), EPROM, hard disk, or ROM. In some implementations, the computer-readable storage medium 300 includes a non-transitory computer-readable storage medium. The computer-readable storage medium 1600 has a storage space for program codes 1610 that execute any operation in the above methods. The program codes may be read from or written to one or more computer program products. The program codes 310 may be compressed, for example, in an appropriate form.

Based on the above, the embodiments of the disclosure provide the resource integration method, the resource integration apparatus, the electronic device and the storage medium. The resource list interface and the resource collection interface are displayed, in which the resource list interface includes the at least one resource. In response to the dragging operation of dragging the target resource of the at least one resource from the resource list interface to the resource collection interface, the thumbnail of the target resource is displayed on the resource collection interface. The integrated resource is obtained based on the target resource included in the resource collection interface. In this way, the user is provided with a highly customized file collection and integration method, which provides easy access for users who send and receive resources frequently, thereby improving user experience.

Finally, it is notable that, the above embodiments are merely intended to illustrate but not to limit the technical solutions of the disclosure. Although the disclosure has been described in detail with reference to the foregoing embodiments, it can be understood that, those of ordinary skill in the art can modify the technical solutions described in the foregoing embodiments or make equivalent substitutions for some technical features therein; and these modifications or substitutions do not drive the essence of the corresponding technical solutions away from the spirit and scope of the technical solutions of the embodiments of the disclosure.

What is claimed is:

1. A resource integration method, comprising:
displaying a resource list interface and a resource collection interface, wherein the resource list interface comprises at least one resource;
in response to a dragging operation of dragging a target resource of the at least one resource from the resource list interface to the resource collection interface, displaying the target resource on the resource collection interface; and
obtaining an integrated resource based on the target resource comprised in the resource collection interface.

2. The resource integration method as claimed in claim 1, wherein a thumbnail of the at least one resource is displayed on the resource list interface, and displaying the target resource on the resource collection interface in response to the dragging operation of dragging the target resource of the at least one resource from the resource list interface to the resource collection interface, comprises:
in response to a dragging operation of dragging a thumbnail of the target resource from the resource list interface to the resource collection interface, displaying the thumbnail of the target resource on the resource collection interface.

3. The resource integration method as claimed in claim 2, wherein displaying the thumbnail of the target resource on the resource collection interface in response to the dragging operation of dragging the thumbnail of the target resource from the resource list interface to the resource collection interface, comprises:
in response to the dragging operation of dragging the thumbnail of the target resource from the resource list interface to the resource collection interface, displaying the thumbnail of the target resource on the resource collection interface, and displaying the thumbnail of the target resource in a target state on the resource list interface, wherein the target state is configured to indicate that the thumbnail of the target resource has been added to the resource collection interface; or
in response to the dragging operation of dragging the thumbnail of the target resource from the resource list interface to the resource collection interface, displaying the thumbnail of the target resource on the resource collection interface, and deleting the thumbnail of the target resource from the resource list interface.

4. The resource integration method as claimed in claim 2, wherein after displaying the thumbnail of the target resource on the resource collection interface, the method further comprises:
in response to a moving operation acting on the thumbnail of the target resource, changing a display position of the thumbnail of the target resource on the resource collection interface.

5. The resource integration method as claimed in claim 4, wherein changing the display position of the thumbnail of the target resource on the resource collection interface in response to the moving operation acting on the thumbnail of the target resource, comprises:
in response to a two-finger dragging operation acting on the thumbnail of the target resource, changing the display position of the thumbnail of the target resource on the resource collection interface.

6. The resource integration method as claimed in claim 5, wherein after displaying the thumbnail of the target resource on the resource collection interface, the method further comprises:
in response to a zooming operation acting on the thumbnail of the target resource, changing a display size of the thumbnail of the target resource on the resource collection interface.

7. The resource integration method as claimed in claim 6, wherein changing the display size of the thumbnail of the target resource on the resource collection interface in response to the zooming operation acting on the thumbnail of the target resource, comprises:
in response to an operation performed with two fingers on the thumbnail of the target resource in which the two fingers slide in opposite directions, scaling up the thumbnail of the target resource on the resource collection interface; or
in response to an operation performed with two fingers on the thumbnail of the target resource in which the two fingers slide toward each other, scaling down the thumbnail of the target resource on the resource collection interface.

8. The resource integration method as claimed in claim 2, wherein after displaying the thumbnail of the target resource on the resource collection interface, the method further comprises:
in response to a first touch operation acting on the thumbnail of the target resource, displaying a plurality of function controls on the resource collection interface; and
in response to a second touch operation acting on a target function control of the plurality of function controls, performing processing corresponding to the target function control on the target resource.

9. The resource integration method as claimed in claim 8, wherein performing the processing corresponding to the target function control on the target resource, comprises:
in response to the target function control being a delete control, deleting the thumbnail of the target resource from the resource collection interface; or
in response to the target function control being a view control, displaying a preview window of the target resource; or
in response to the target function control being a share control, sharing the target resource with a to-be-shared object.

10. The resource integration method as claimed in claim 1, wherein displaying the target resource on the resource collection interface, comprises:
displaying the target resource and attribute information of the target resource on the resource collection interface, wherein the attribute information comprises at least one of a name, a type, and a size.

11. The resource integration method as claimed in claim 1, wherein after obtaining the integrated resource based on the target resource comprised in the resource collection interface, the method further comprises:
displaying a plurality of sharing channels in response to a sharing operation for the integrated resource; and
in response to a third touch operation acting on a target sharing channel of the plurality of sharing channels, sharing the integrated resource to a to-be-shared object through the target sharing channel.

12. The resource integration method as claimed in claim 1, wherein after obtaining the integrated resource based on the target resource comprised in the resource collection interface, the method further comprises:
displaying a plurality of sharing manners in response to a sharing operation acting on the integrated resource; and
in response to a fourth touch operation acting on a target sharing manner of the plurality of sharing manners, sharing the integrated resource to a to-be-shared object through the target sharing manner.

13. The resource integration method as claimed in claim 1, wherein displaying the resource list interface and the resource collection interface, comprises:
displaying the resource list interface and the resource collection interface, wherein the resource list interface comprises at least one resource type control, and each of the at least one resource type control is configured to trigger displaying of at least one resource of a type corresponding to the resource type control; and
in response to a fifth touch operation acting on a target resource type control of the at least one resource type control, displaying, on the resource list interface, at least one resource of a type corresponding to the target resource type control.

14. The resource integration method as claimed in claim 1, wherein the method further comprises:
in response to a target touch operation acting on the resource list interface, switching displaying of the at least one resource on the resource list interface.

15. The resource integration method as claimed in claim 14, wherein a scroll bar is displayed on the resource list interface, and switching the displaying of the at least one resource on the resource list interface, comprises:
in response to a target sliding operation acting on the scroll bar, switching the displaying of the at least one resource on the resource list interface.

16. The resource integration method as claimed in claim 1, wherein before displaying the target resource on the resource collection interface in response to the dragging operation of dragging the target resource of the at least one resource from the resource list interface to the resource collection interface, the method further comprises:
in response to detecting a touch operation acting on the resource list interface and a dragging operation performed based on the touch operation, acquiring a touch position of the touch operation; and
determining, from the at least one resource, a resource whose display position corresponds to the touch position as the target resource.

17. The resource integration method as claimed in claim 1, wherein obtaining the integrated resource based on the target resource comprised in the resource collection interface, comprises:
after the target resource is dragged to the resource collection interface and displayed in the on the resource collection interface, in response to receiving instruction information indicating confirmation, obtaining the integrated resource based on the target resource comprised in the resource collection interface.

18. An electronic device, comprising a memory and a processor, wherein the memory is coupled to the processor, the memory stores instructions which, when being executed by the processor, cause the processor to execute a resource integration method, wherein the method comprises:
displaying a resource list interface and a resource collection interface, wherein the resource list interface comprises at least one resource;
in response to a dragging operation of dragging a target resource of the at least one resource from the resource list interface to the resource collection interface, displaying the target resource on the resource collection interface; and
obtaining an integrated resource based on the target resource comprised in the resource collection interface.

19. The electronic device as claimed in claim 18, wherein the method further comprises:
in response to a touch operation performed with at least two different fingers acting on at least two resources on the resource list interface respectively, determining the at least two resources as target resources; and
wherein displaying the target resource on the resource collection interface in response to the dragging operation of dragging the target resource of the at least one resource from the resource list interface to the resource collection interface, comprises:
in response to a dragging operation performed based on the touch operation acting on the target resources, displaying the target resources on the resource collection interface.

20. A computer-readable storage medium having program codes stored thereon, wherein the program codes are callable by a processor to execute a resource integration method, wherein the method comprises:
displaying a resource list interface and a resource collection interface, wherein the resource list interface comprises at least one resource;
in response to a dragging operation of dragging a target resource of the at least one resource from the resource list interface to the resource collection interface, displaying the target resource on the resource collection interface; and
obtaining an integrated resource based on the target resource comprised in the resource collection interface.
